(19) United States
(12) Patent Application Publication
(10) Pub. No.: US 2023/0405627 A1
(43) Pub. Date: Dec. 21, 2023

(54) SQUEEGEE AND POWDER COATING APPARATUS

(71) Applicant: Panasonic Intellectual Property Management Co., Ltd., Osaka (JP)

(72) Inventors: AKIHIRO HORIKAWA, Osaka (JP); TOSHIYUKI KOJIMA, Kyoto (JP)

(21) Appl. No.: 18/460,644

(22) Filed: Sep. 4, 2023

Related U.S. Application Data
(63) Continuation of application No. PCT/JP2022/008947, filed on Mar. 2, 2022.

(30) Foreign Application Priority Data
Mar. 18, 2021 (JP) 2021-045203

(51) Int. Cl. B05C 1/06; B05C 19/04; B05C 19/00

(52) U.S. Cl. CPC B05C 1/06; B05C 19/04; B05C 19/008

(57) ABSTRACT

A squeegee is to be relatively moved in a certain direction while a desired gap is being formed with respect to a base material to uniformly level a thickness of a powder layer including powder supplied on the base material, and includes: a first portion that vibrates in contact with the powder on an upstream side of a relative movement direction of the base material with respect to the squeegee; and a second portion that vibrates in contact with the powder on a downstream side of the relative movement direction of the base material with respect to the squeegee, a vibration direction of the first portion being different from a vibration direction of the second portion.

### TECHNICAL FIELD

The present disclosure relates to a squeegee and a powder coating apparatus.

### BACKGROUND ART

Conventionally, a technique of coating powder onto a surface of a member such as a metal foil while conveying the member is widely known.

For example, PTL 1 discloses a technique of coating a composite material (a powder) including an active material onto a surface of a current collector as a long metal foil.

Furthermore, PTL 2 discloses a method of applying vibration at a frequency of about 700 Hz to a cylindrical squeegee to suppress retention of powder.

### CITATION LIST

### Patent Literatures

PTL 1: Unexamined Japanese Patent Publication No. 2011-216504
PTL 2: Unexamined Japanese Patent Publication No. 2014-198293

### SUMMARY OF THE INVENTION

A squeegee according to one aspect of the present disclosure is to be moved relative to a base material in a direction while a desired gap is being formed between the squeegee and the base material to uniformly level a thickness of a powder layer including powder supplied onto the base material, and includes: a first portion that vibrates in contact with the powder on an upstream side of a relative movement direction of the base material with respect to the squeegee; and a second portion that vibrates in contact with the powder on a downstream side of the relative movement direction of the base material with respect to the squeegee, a vibration direction of the first portion being different from a vibration direction of the second portion.

### BRIEF DESCRIPTION OF THE DRAWINGS

FIG. 1A is a schematic view illustrating powder coating apparatus 2 according to a first exemplary embodiment.

FIG. 1B is a schematic view illustrating squeegee 1 and powder coating apparatus 2 according to the first exemplary embodiment.

FIG. 2A is a vector diagram illustrating force applied to powder 4 due to contact of powder 4 with surface 5a of portion 5 in a case where portion 5 is vibrated in a direction where an angle between surface 3a of base material 3 and a vibration direction of portion 5 is 90° in FIG. 1B. Here, FIG. 2A is a vector diagram illustrating force 111a (resultant force of force 104a causing powder 4 conveyed to base material 3 to push surface 5a of portion 5 and force 110a applied to powder 4 from portion 5 in vibration) that causes powder 4 to push surface 5a of portion 5 when surface 5a of portion 5 approaches base material 3 side.

FIG. 2B is a vector diagram illustrating force 105a obtained by decomposing force 111a causing powder 4 to push surface 5a of portion 5 in FIG. 2A to vertically push surface 5a of portion 5, and force 112 received by powder 4 from portion 5 as drag against force 105a.

FIG. 2C is a vector diagram illustrating a case where portion 5 is separated from base material 3.

FIG. 3 is a schematic view of squeegee 1 and powder coating apparatus 2 according to a second exemplary embodiment.

FIG. 4A is a vector diagram illustrating force applied to powder 4 due to contact of powder 4 with surface 5a of portion 5 in a case where vibration is performed in a direction where portion 5 and surface 3a of base material 3 approach each other toward an upstream side and are separated from each other toward a downstream side of relative movement direction 7 of base material 3 with respect to squeegee 1, rather than in a direction where an angle between a vibration direction of portion 5 and surface 3a of base material 3 is 90° in FIG. 3. Here, FIG. 4A is a vector diagram illustrating force 111a (resultant force of force 104a causing powder 4 to push surface 5a of portion 5 by being conveyed to base material 3 and force 110a applied to powder 4 from portion 5 in vibration) that causes powder 4 to push surface 5a of portion 5 when surface 5a of portion 5 approaches base material 3 side.

FIG. 4B is a vector diagram illustrating force 105a obtained by decomposing force 111a causing powder 4 to push surface 5a of portion 5 in FIG. 4A to vertically push surface 5a of portion 5, and force received by powder 4 from portion 5 as drag against force 105a.

FIG. 4C is a vector diagram illustrating a case where portion 5 is separated from base material 3.

FIG. 5 is a schematic view of squeegee 1 and powder coating apparatus 2 as a third exemplary embodiment.

FIG. 6A is a vector diagram illustrating force applied to powder 4 due to contact of powder 4 with surface 5a of portion 5 in a case where portion 5 is vibrated to approach base material 3 toward a downstream side and to be separated from base material 3 toward an upstream side of relative movement direction 7 of base material 3 with respect to squeegee 1 in FIG. 5. Here, FIG. 6A is a vector diagram illustrating force 111a (resultant force of force 104a causing powder 4 to push surface 5a of portion 5 by being conveyed to base material 3 and force 110a applied to powder 4 from portion 5 in vibration) that causes powder 4 to push surface 5a of portion 5 when surface 5a of portion 5 approaches base material 3 on a downstream side of relative movement direction 7 of base material 3 with respect to squeegee 1.

FIG. 6B is a vector diagram illustrating force 105a obtained by decomposing force 111a causing powder 4 to push surface 5a of portion 5 in FIG. 6A to vertically push surface 5a of portion 5, and force received by powder 4 from portion 5 as drag against force 105a.

FIG. 6C is a vector diagram illustrating force 111a causing powder 4 to push surface 5a of portion 5 when portion 5 is separated from base material 3.

FIG. 6D is a vector diagram illustrating force 105a obtained by decomposing force 111a causing powder 4 to push surface 5a of portion 5 in FIG. 6C to vertically push surface 5a of portion 5, and force received by powder 4 from portion 5 as drag against the force.

FIG. 7 is a schematic view of positive electrode mixture layer 10 as viewed from above, illustrating a film thickness measurement position as an exemplary embodiment.

FIG. 8 is a cross-sectional view of a part of positive electrode mixture layer 10 of an all-solid-state battery as an exemplary embodiment.

FIG. 9 is a schematic view of a conventional technique using blade-shaped squeegee 100 for powder 4.

FIG. 10 is a vector diagram illustrating force applied to powder 4 when powder 4 comes into contact with blade-shaped squeegee 100.

FIG. 11 illustrates a schematic view of a conventional technique of vibrating cylindrical squeegee 150.

FIG. 12 is a vector diagram illustrating force applied to powder 4 due to contact of powder 4 with cylindrical squeegee 150 free of vibration.

FIG. 13A is a vector diagram illustrating force applied to powder 4 when powder 4 comes into contact with cylindrical squeegee 150 vibrated in a vibration direction A (a direction parallel to movement direction 7) while shortest distance 109 between cylindrical squeegee 150 vibrated in the vibration direction A and base material 3 is being maintained in FIG. 11. Here, FIG. 13A is a vector diagram illustrating force 111 (resultant force of force 104 due to base material conveyance and force 110 applied to powder 4 from squeegee 150 in vibration) causing powder 4 to push squeegee 150 when squeegee 150 moves in a direction opposite to relative movement direction 7 of base material 3 with respect to squeegee 150 as movement of squeegee 150 in vibration in one direction.

FIG. 13B is a vector diagram illustrating force 105 that is a part of force obtained by decomposing force 111 causing powder 4 to push squeegee 150 in FIG. 13A and vertically pushes squeegee 150, and force received by powder 4 from squeegee 150 as drag against the force.

FIG. 13C is a vector diagram illustrating a case where cylindrical squeegee 150 moves in the same direction as relative movement direction 7 of base material 3 with respect to squeegee 150.

FIG. 14A is a vector diagram illustrating force applied to powder 4 due to contact of powder 4 with cylindrical squeegee 150 vibrated in a vibration direction B in FIG. 11. Here, FIG. 14A is a vector diagram illustrating a case where force 111 (resultant force of force 104 due to conveyance of base material 3 and force 110 applied to powder 4 from squeegee 150 in vibration) is viewed from above (powder 4 is viewed through squeegee 150) that causes powder 4 to push squeegee 150 when cylindrical squeegee 150 is vibrating in one direction perpendicular to relative movement direction 7 of base material 3 while shortest distance 109 between squeegee 150 and base material 3 is being maintained.

FIG. 14B is a vector diagram illustrating a case where force 107 received by powder 4 from squeegee 150 is viewed from a side as drag against force 105 obtained by decomposing force 111 causing powder 4 to push squeegee 150 in FIG. 14A.

FIG. 15 is Table 1 showing results of each exemplary embodiment according to the present disclosure.

FIG. 16 is Table 2 showing results of comparative examples according to a conventional technique.

### DESCRIPTION OF EMBODIMENT

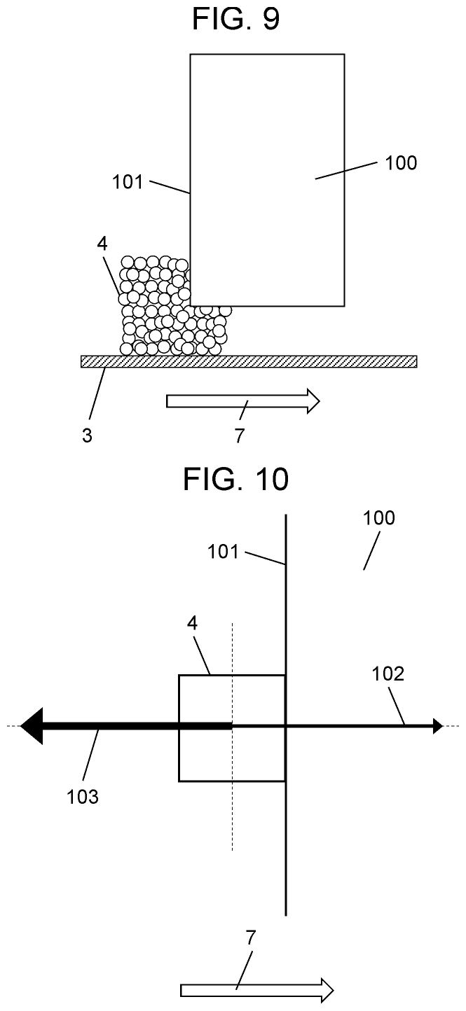

Matters of PTL 1 will be described with reference to FIGS. 9 and 10. FIG. 9 is a schematic view of a conventional technique using blade-shaped squeegee 100 described in PTL 1. Furthermore, FIG. 10 is a vector diagram illustrating force applied to powder 4 when powder 4 comes into contact with blade-shaped squeegee 100.

PTL 1 describes, as shown in FIG. 9, that a thickness of a powder layer is uniformly adjusted by leveling powder 4 with blade-shaped squeegee 100 after powder 4 is supplied onto a surface of a metal foil as base material 3.

However, as illustrated in FIG. 10, when powder 4 comes into contact with surface 101 of squeegee 100, powder 4 receives force 103 in a direction opposite to a movement direction of powder 4 (relative movement direction 7 of base material 3 (a metal foil) with respect to squeegee 100) as drag against force 102 causing powder 4 to vertically push a contact surface of squeegee 100 (surface 101 of the squeegee), and therefore, in a case where fluidity of powder 4 is low, powder 4 is likely to be retained on an upstream side of relative movement direction 7 of base material 3 (the metal foil) with respect to squeegee 100. For such reason, a bridge is likely to occur between squeegee 100 and base material 3 (the metal foil).

In order to suppress the retention of powder 4 and the occurrence of the bridge, it is important to reduce force 103 that is in the direction opposite to the movement direction of the powder (relative movement direction 7 of base material 3 (the metal foil) with respect to squeegee 100) and received from squeegee 100 as the drag against force 102 causing powder 4 to vertically push the contact surface of squeegee 100 (surface 101 of the squeegee).

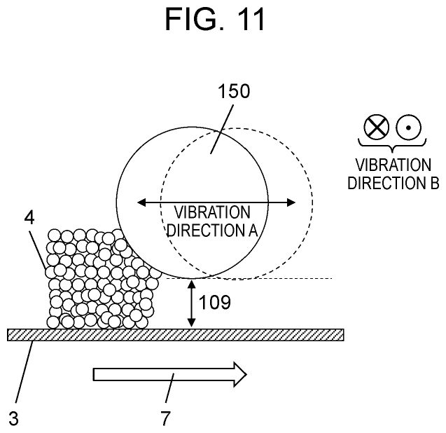

Matters of PTL 2 will be described with reference to FIGS. 11, 12, and 13A to 13C.

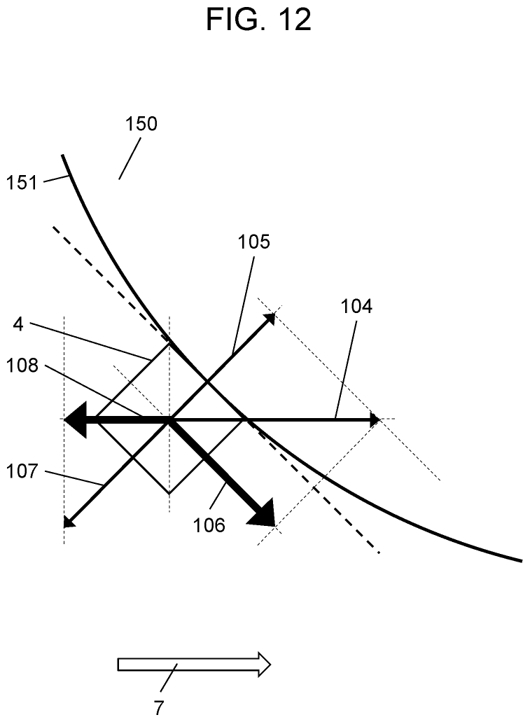

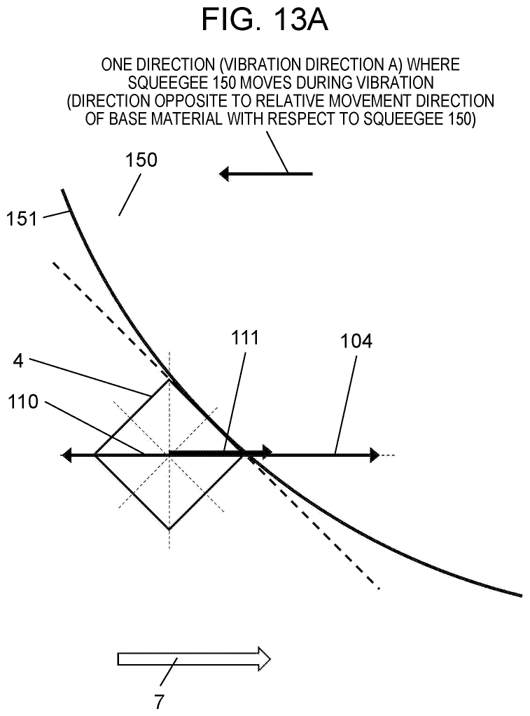

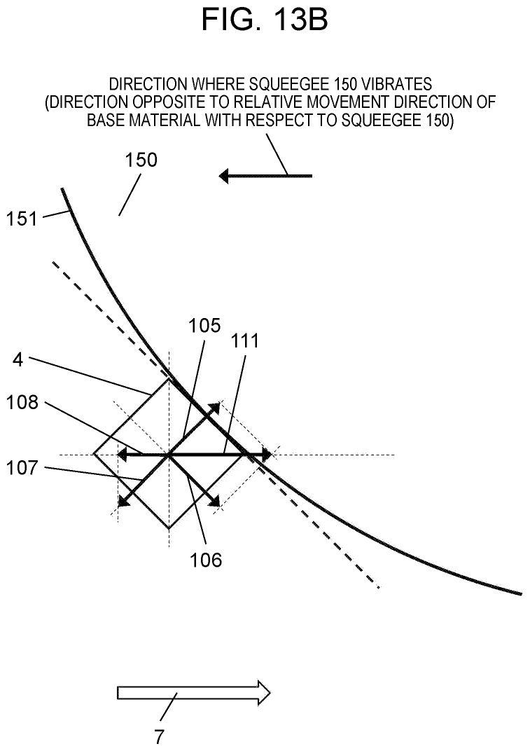

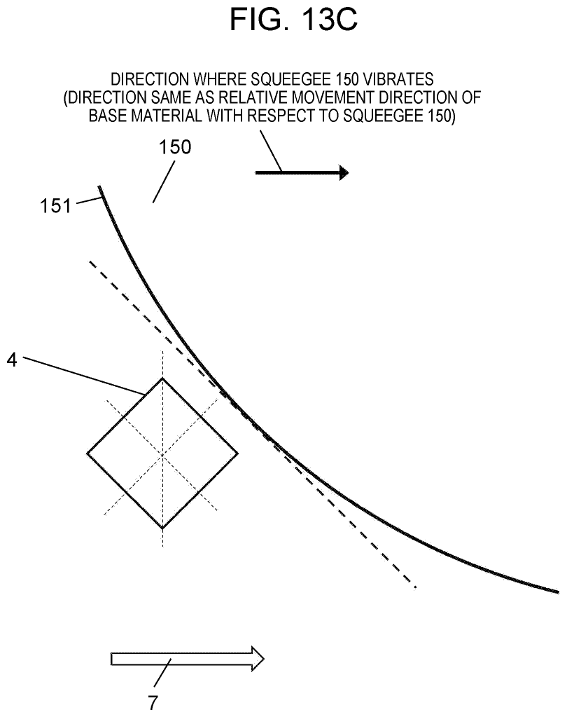

FIG. 11 illustrates a schematic view of a conventional technique of vibrating cylindrical squeegee 150 described in PTL 2. Furthermore, FIG. 12 is a vector diagram illustrating force applied to powder 4 due to contact of powder 4 with cylindrical squeegee 150 free of vibration. Furthermore, FIGS. 13A to 13C are vector diagrams illustrating force applied to powder 4 when powder 4 comes into contact with cylindrical squeegee 150 vibrated in a vibration direction A (a direction parallel to movement direction 7) while shortest distance 109 between cylindrical squeegee 150 vibrated in the vibration direction A and base material 3 is being maintained in FIG. 11. Here, FIG. 13A is a vector diagram illustrating force 111 (resultant force of force 104 due to base material conveyance and force 110 applied to powder 4 from squeegee 150 in vibration) causing powder 4 to push squeegee 150 when squeegee 150 moves in a direction opposite to relative movement direction 7 of base material 3 with respect to squeegee 150 as movement of squeegee 150 in vibration to one direction. Furthermore, FIG. 13B is a vector diagram illustrating force 105 that is a part of force obtained by decomposing force 111 causing powder 4 to push squeegee 150 in FIG. 13A and vertically pushes squeegee 150, and force 107 received by powder 4 from squeegee 150 as drag against the force. Furthermore, FIG. 13C is a vector diagram illustrating a case where cylindrical squeegee 150 moves in the same direction as relative movement direction 7 of base material 3 with respect to squeegee 150 as movement of squeegee 150 in vibration to the other direction.

As for cylindrical squeegee 150 described in PTL 2 as illustrated in FIG. 11, unlike blade-shaped squeegee 100 described in PTL 1 illustrated in FIG. 9, force 104 causing powder 4 to push squeegee 150 by being conveyed to base material 3 as illustrated in FIG. 12 is decomposed into force 105 for vertically pushing a contact surface of squeegee 150 (squeegee surface 151) and force 106 for sliding on the contact surface of the squeegee (squeegee surface 151). Powder 4 receives force 107 directed to an outer side of a cylinder (squeegee 150) in a radial direction as drag against force 105 for vertically pushing the contact surface of squeegee 150 (squeegee surface 151). However, since force 107 directed to the outer side of the cylinder (squeegee 150) in the radial direction includes component 108 in a direction opposite to relative movement direction 7 of base material 3, in a case where the fluidity of powder 4 is low, powder 4 is likely to be retained on the upstream side of relative movement direction 7 of base material 3 with respect to cylindrical squeegee 150. Therefore, the bridge occurs between cylindrical squeegee 150 and base material 3 (the metal foil).

In order to suppress the retention of powder 4 and the occurrence of the bridge for cylindrical squeegee 150, it is important to reduce force 107 received from squeegee 150 directed to the outer side of squeegee 150 as the cylinder in the radial direction as drag against force 105 causing powder 4 to vertically push the contact surface of squeegee 150 (squeegee surface 151), that is, to reduce the component of the force in the direction opposite to the movement direction of powder 4 (relative movement direction 7 of base material 3).

Furthermore, in order to suppress the retention of powder 4 and the occurrence of the bridge, it is also effective to increase force 106 obtained by decomposing force 104 causing powder 4 to push squeegee 150 by being conveyed to base material 3 to slide on the contact surface of squeegee 150 (squeegee surface 151). This is because powder 4 can be promoted to enter into the gap between squeegee 150 and base material 3 by increasing force 106.

Next, a case will be similarly described where cylindrical squeegee 150 described in PTL 2 as illustrated in FIG. 11 is vibrated along a vibration direction A in FIG. 11 including relative movement direction 7 of base material 3 with respect to squeegee 150 and an opposite direction of relative movement direction 7 while shortest distance 109 between squeegee 150 and base material 3 is being maintained.

First, in a case where squeegee 150 is vibrating in a direction opposite to relative movement direction 7 of base material 3, as illustrated in FIG. 13A, the resultant force of force 104 causing powder 4 to push squeegee 150 and force 110 applied to powder 4 from squeegee 150 in vibration becomes force 111 causing powder 4 to push the squeegee by conveying powder 4 to base material 3. As illustrated in FIG. 13B, force 111 causing powder 4 to push squeegee 150 can be decomposed into force 105 for vertically pushing the contact surface of squeegee 150 (squeegee surface 151) and force 106 for sliding on the contact surface (squeegee surface 151). Powder 4 receives force 107 directed to the outer side of the cylinder in the radial direction as the drag against force 105 for vertically pushing the contact surface of squeegee 150 (squeegee surface 151). Here, force 107 includes component 108 in the direction opposite to relative movement direction 7 of base material 3. Although component 108 is small compared to the case shown in FIG. 12 where squeegee 150 does not vibrate, in the case where the fluidity of powder 4 is low, powder 4 is retained on the upstream side of relative movement direction 7 of base material 3. Therefore, the bridge occurs between cylindrical squeegee 150 and base material 3 (the metal foil). Furthermore, as compared with a case shown in FIG. 12 where squeegee 150 does not vibrate, since force 106 for sliding on the contact surface of the squeegee (squeegee surface 151) is reduced, powder 4 cannot be promoted to enter into the gap between squeegee 150 and base material 3. Furthermore, in the case where the fluidity of powder 4 is low, powder 4 is retained on the upstream side of relative movement direction 7 of base material 3. Therefore, the bridge occurs between cylindrical squeegee 150 and base material 3 (the metal foil).

Furthermore, when cylindrical squeegee 150 vibrates in the same direction as relative movement direction 7 of base material 3, as illustrated in FIG. 13C, since squeegee 150 moves in a direction away from powder 4, squeegee 150 has no effect on powder 4 to suppress the retention and the occurrence of the bridge.

Accordingly, in a case where cylindrical squeegee 150 described in PTL 2 is vibrated in relative movement direction 7 of base material 3 and the opposite direction (the vibration direction A in FIG. 11) of relative movement direction 7 while shortest distance 109 between squeegee 150 and base material 3 is being maintained, states illustrated in FIGS. 13B and 13C are repeated. For this reason, force 107, which is applied to powder 4 from squeegee 150 toward the outer side of the cylinder in the radial direction, includes component 108 in the direction opposite to relative movement direction 7 of base material 3 with respect to squeegee 150, although component 108 is small compared to the case where squeegee 150 does not vibrate, and therefore, force 106 for sliding on the contact surface of squeegee 150 (squeegee surface 151) becomes smaller than that in the case where squeegee 150 does not vibrate. Therefore, powder 4 cannot be promoted to enter into the gap between squeegee 150 and base material 3. For such reason, for example, in the case where powder 4 having a very small particle diameter of several tens μm to submicron size is likely to aggregate and the fluidity of powder 4 is low, the effect of suppressing the retention of powder 4 and the occurrence of the bridge is insufficient, and it is difficult to uniformly level the powder layer to make the thickness of the powder layer uniform.

Next, a case will be similarly described where cylindrical squeegee 150 described in PTL 2 is vibrated in a direction (the vibration direction B in FIG. 11) perpendicular to relative movement direction 7 of base material 3 with respect to squeegee 150 while shortest distance 109 between squeegee 150 and base material 3 is being maintained.

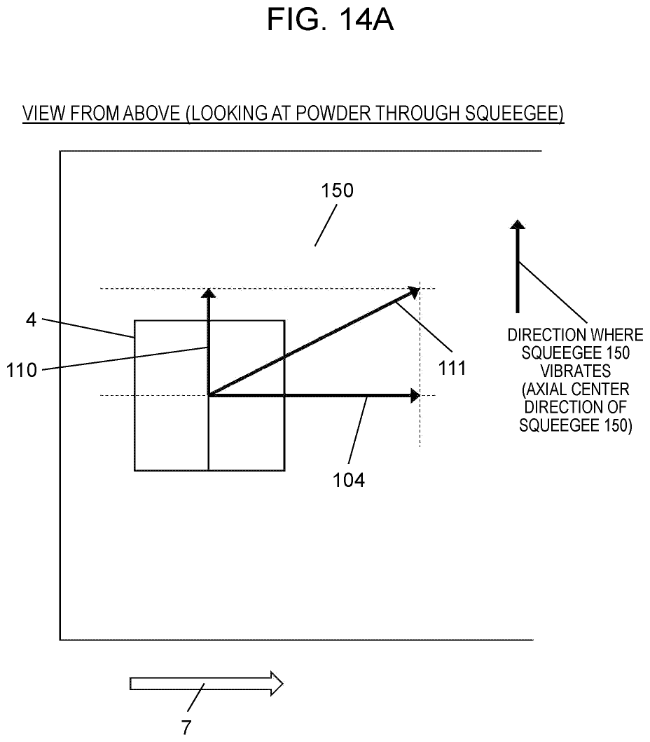

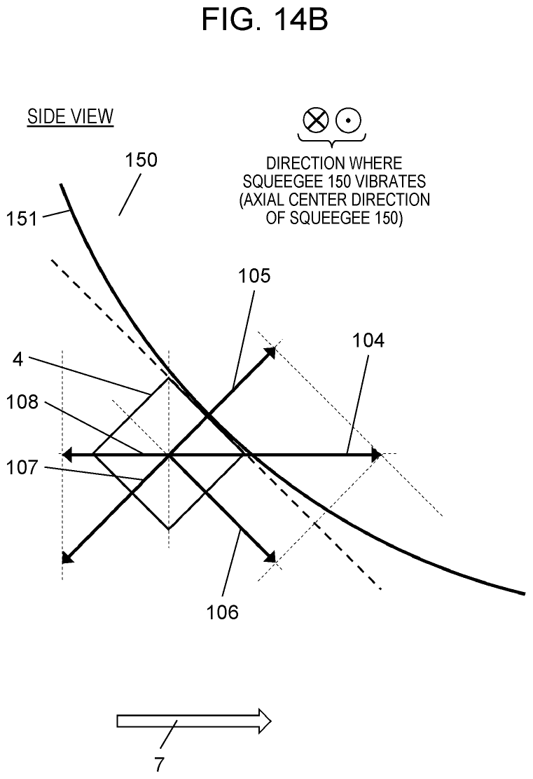

FIGS. 14A and 14B are vector diagrams illustrating force applied to powder 4 due to contact of powder 4 with cylindrical squeegee 150 vibrated in a vibration direction B in FIG. 11.

Here, FIG. 14A is a vector diagram illustrating a case where force 111 (resultant force of force 104 due to conveyance of base material 3 and force 110 applied to powder 4 from squeegee 150 in vibration) is viewed from above (powder 4 is viewed through squeegee 150) that causes powder 4 to push squeegee 150 when cylindrical squeegee 150 is vibrating in one direction perpendicular to relative movement direction 7 of base material 3 while shortest distance 109 between squeegee 150 and base material 3 is being maintained. Furthermore, FIG. 14B is a vector diagram illustrating a case where force 107 received by powder 4 from squeegee 150 is viewed from a side as drag against force 105 obtained by decomposing force 111 causing powder 4 to push squeegee 150 in FIG. 14A.

First, when squeegee 150 is vibrating in one direction perpendicular to relative movement direction 7 of base material 3 while shortest distance 109 between squeegee 150 and base material 3 is being maintained, as illustrated in FIG. 14A, the resultant force of force 104 causing powder 4 to push squeegee 150 by being conveyed to base material 3 and force 110 applied to the powder from squeegee 150 in vibration becomes force 111 causing powder 4 to push the squeegee. Here, as illustrated in FIG. 14B, in a case where the force is decomposed into force 105 for vertically pushing the contact surface of squeegee 150 (squeegee surface 151) and force 106 for sliding on the contact surface of squeegee 150 (squeegee surface 151), substantially, force 110 applied to powder 4 from squeegee 150 in vibration does not work, and only force 104 causing powder 4 to push squeegee 150 by being conveyed to base material 3 works. In other words, a similar state will occur as in a case where powder 4 comes into contact with cylindrical squeegee 150 free of vibration illustrated in FIG. 12. As a result, powder 4 receives force 107 directed to the outer side of the cylinder in the radial direction as the drag against force 105 for vertically pushing the contact surface of squeegee 150 (squeegee surface 151). Force 107 directed to the outer side of the cylinder in the radial direction includes component 108 in the direction opposite to relative movement direction 7 of base material 3, similar to the case shown in FIG. 12 where squeegee 150 does not vibrate. Furthermore, force 106 for sliding on the contact surface (squeegee surface 151) is also little changed from the case shown in FIG. 12 where squeegee 150 does not vibrate, and an improvement effect cannot be obtained. For such reasons, in the case where the fluidity of powder 4 is low, powder 4 is retained on the upstream side of cylindrical squeegee 150 in relative movement direction 7 of base material 3. Therefore, the bridge occurs between cylindrical squeegee 150 and base material 3 (the metal foil).

Here, the case where cylindrical squeegee 150 is vibrating in one direction perpendicular to relative movement direction 7 of base material 3 while shortest distance 109 between squeegee 150 and base material 3 is being maintained has been described. A case where squeegee is vibrating in opposite direction will also be in a similar state, and therefore, description of this case will be omitted.

Accordingly, in the case where cylindrical squeegee 150 described in PTL 2 is vibrated in the direction (the vibration direction B in FIG. 11) perpendicular to relative movement direction 7 of base material 3 while shortest distance 109 between cylindrical squeegee 150 and base material 3 is being maintained, due to the state illustrated in FIGS. 14A and 14B, force 107 directed to the outer side of the cylinder in the radial direction includes component 108 in the direction opposite to relative movement direction 7 of base material 3 similarly as in the case where squeegee 150 does not vibrate. Furthermore, compared with the case where squeegee 150 does not vibrate, an effect of improving force 106 for sliding on the contact surface of squeegee 150 (squeegee surface 151) cannot be obtained, and powder 4 cannot be promoted to enter into the gap between squeegee 150 and base material 3. For such reason, for example, in the case where powder 4 having a very small particle diameter of several tens μm to submicron size is likely to aggregate and the fluidity of powder 4 is low, the effect of suppressing the retention of powder 4 and the occurrence of the bridge is insufficient, and it is difficult to evenly level the powder layer to make the thickness of the powder layer uniform.

Therefore, an object of the present disclosure is to provide a squeegee and a powder coating apparatus capable of forming a powder layer with less variation in film thickness on a surface of a base material.

Exemplary embodiments of the present invention will be described below with reference to drawings. Note that each of the exemplary embodiments described below is intended to provide comprehensive or specific examples. Numerical values, shapes, materials, components, dispositions and connection modes of the components, steps, order of the steps, and the like shown in the exemplary embodiments below are merely examples, and are not intended to limit the present disclosure. Furthermore, among the components in the exemplary embodiments below, components that are not described in independent claims will be described as optional components.

Furthermore, each drawing is a schematic view, and is not necessarily illustrated in a precise manner. In each drawing, substantially the same configurations are designated by the same reference numerals, and duplicate description may be omitted or simplified.

Note that in the description below, terms indicating relationships between the elements such as uniform, parallel, flat, and orthogonal, and terms indicating shapes of the elements such as powdery, as well as numerical ranges are not meant to express a strict meaning only, but also to include substantially equivalent ranges, for example, differences of about several percent.

Furthermore, the exemplary embodiments will be described below with reference to the drawings as appropriate, but detailed description more than necessary may be omitted. For example, detailed description of well-known matters and duplicate description of substantially the same configurations may be omitted. This is to avoid an unnecessarily redundant description below and to facilitate understanding of a person skilled in the art.

### First Exemplary Embodiment

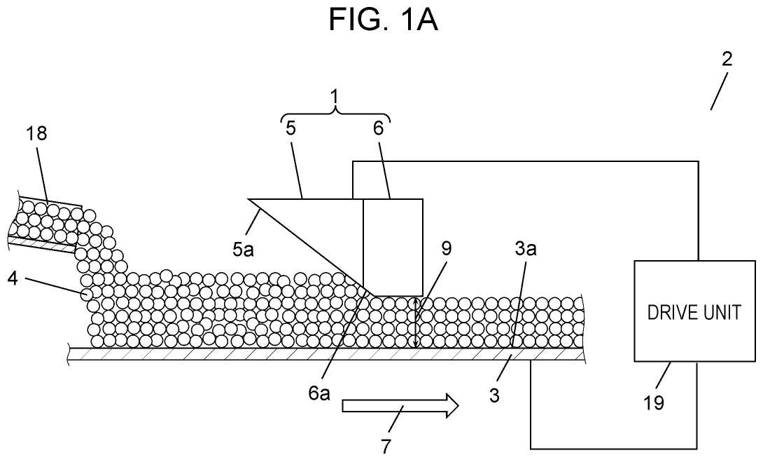

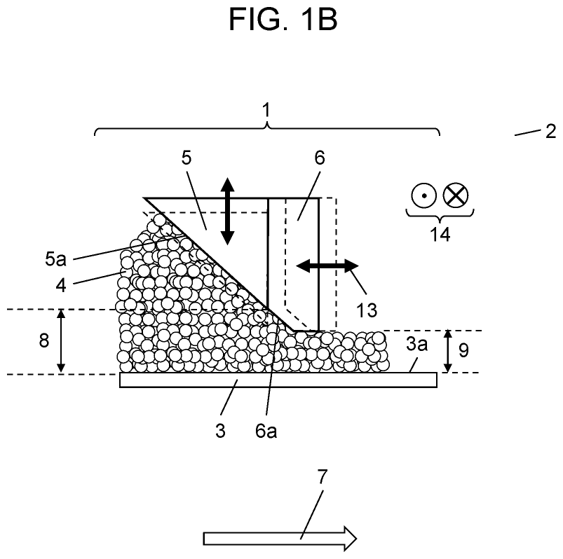

FIG. 1A is a schematic view illustrating a powder coating apparatus according to a first exemplary embodiment. FIG. 1B is a schematic view illustrating squeegee 1 and powder coating apparatus 2 according to the first exemplary embodiment. Furthermore, FIG. 1B illustrates shortest distance 8 between portion 5 and base material 3 due to vibration of portion 5 and shortest distance 9 between portion 6 and base material 3 due to vibration of portion 6. Note that shortest distance 8 between portion 5 and base material 3 may change, and is not limited to a certain value.

As illustrated in FIG. 1A, powder coating apparatus 2 is an apparatus that coats powder 4 onto surface 3a of base material 3 while conveying base material 3 in a sheet shape by a conveyor as a driver. Specifically, powder coating apparatus 2 continuously supplies powder 4 onto surface 3a of base material 3 by using powder supply unit 18 while conveying base material 3 by the conveyor. Furthermore, powder coating apparatus 2 may also form a powder layer on a surface of base material 3 by continuously compressing base material 3 and powder 4 on base material 3 together by a roll press.

Powder coating apparatus 2 includes: powder supply unit 18 that supplies powder 4 onto surface 3a of base material 3; squeegee 1 that is disposed to allow a gap to be formed between squeegee 1 and base material 3 and adjusts a thickness of a powder layer including powder 4 supplied onto base material 3; and drive unit 19 that relatively moves base material 3 and squeegee 1 in a certain direction.

Such squeegee 1 can be relatively moved in a certain direction while a desired gap is being formed with respect to base material 3 to evenly (uniformly) level (flatten) the thickness of the powder layer including powder 4 supplied onto base material 3. Furthermore, as for squeegee 1, a vibration direction of portion 5 (a first portion) vibrating in contact with powder 4 on an upstream side of relative movement direction 7 of base material 3 with respect to squeegee 1 is different from a vibration direction of portion 6 (a second portion) vibrating in contact with powder 4 on a downstream side of relative movement direction 7 of base material 3 with respect to squeegee 1.

The vibration direction of portion 5 is a direction where powder 4 is crushed. Furthermore, the vibration direction of portion 6 is a direction where powder 4 is flattened.

More specifically, the vibration direction of portion 5 is a direction where surface 5a of portion 5 vibrating in contact with powder 4 approaches and is separated from base material 3. Furthermore, the vibration direction of portion 6 is a direction where portion 6 vibrates while shortest distance 9 between surface 6a of portion 6 vibrating in contact with powder 4 and base material 3 is being maintained. For example, the vibration direction of portion 6 may be parallel to movement direction 7 of base material 3 as vibration direction 13 of portion 6, and may be orthogonal to the movement direction of base material 3 as vibration direction 14 of portion 6. In other words, squeegee 1 allows portion 5 and portion 6 to vibrate in different directions. Furthermore, in the present exemplary embodiment, the vibration direction of portion 5 and the vibration direction of portion 6 are orthogonal to each other.

In the present exemplary embodiment, portion 5 and portion 6 are driven by drive unit 19, but not limited thereto. For example, drive unit 19 may include a vibration generator and a conveyor. The vibration generator causes each of portion 5 and portion 6 to vibrate in different directions. Specifically, the vibration generator causes each of portion 5 and portion 6 to vibrate at a high frequency in a band of more than or equal to 2 kHz and 300 kHz by applying vibration at a high frequency near an ultrasonic band to each of portion 5 and portion 6. Such vibration generator applies vibration to each of portion 5 and portion 6 simultaneously or individually. The conveyor can convey base material 3 together with powder 4 by moving base material 3 in a predetermined direction. The conveyor continuously feeds base material 3 from a roll of base material 3 or intermittently feeds base material 3.

Portion 5 vibrates along a direction (an approach or separation direction) where an angle between surface 3a of base material 3 and the vibration direction is 90°. In other words, the vibration direction of portion 5 is a direction perpendicular to base material 3. Furthermore, portion 6 vibrates while shortest distance 9 between surface 6a of portion 6 vibrating in contact with powder 4 and surface 3a of base material 3 is being maintained. In other words, portion 6 vibrates along a direction parallel to surface 3a of base material 3. Here, shortest distance 9 means a distance of a narrowest part of the gap between portion 6 and base material 3.

Furthermore, powder coating apparatus 2 in the present exemplary embodiment includes: powder supply unit 18 that continuously supplies powder 4 onto surface 3a of base material 3; squeegee 1 that is disposed to allow a gap to be formed between squeegee 1 and base material 3 and adjusts the thickness of the powder layer including powder 4 supplied onto base material 3; and drive unit 19 that relatively moves base material 3 and squeegee 1 in a certain direction (the same or different directions), respectively.

The frequency causing portion 5 and portion 6 of squeegee 1 to vibrate is, for example, from 2 kHz to 300 kHz inclusive.

It is only necessary that powder 4 is a powdery material, and for example, a group of particles including an active material having an average particle diameter (D50) from 0.005 μm to 50 μm inclusive can be used. Note that the average particle diameter (D50) may be a volume-based median diameter calculated from a measured value of particle size distribution by a laser diffraction and scattering method. The average particle diameter (D50) can be measured by using a commercially available laser analysis and scattering type particle size distribution measurement apparatus.

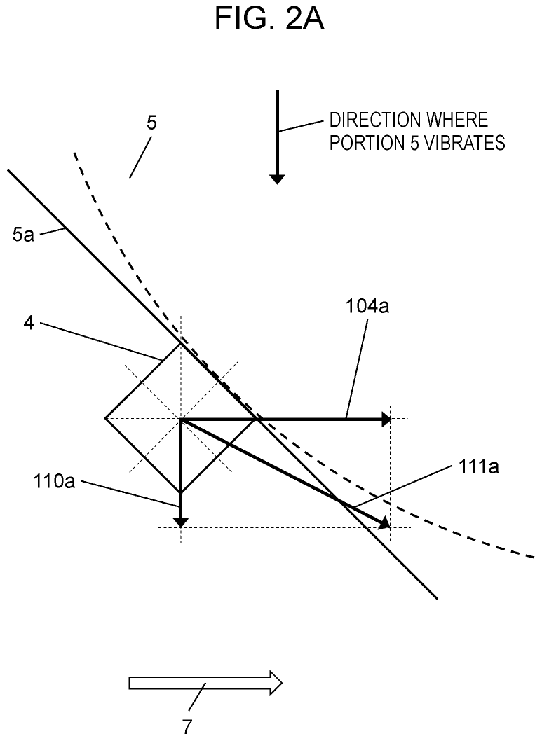

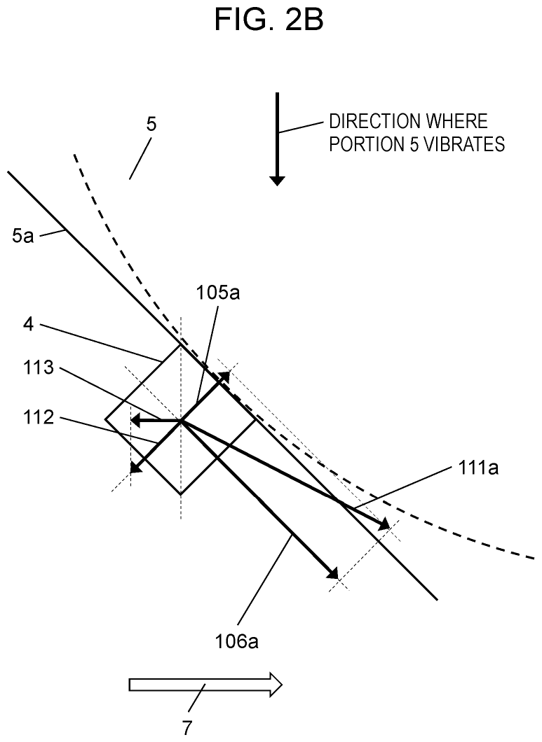

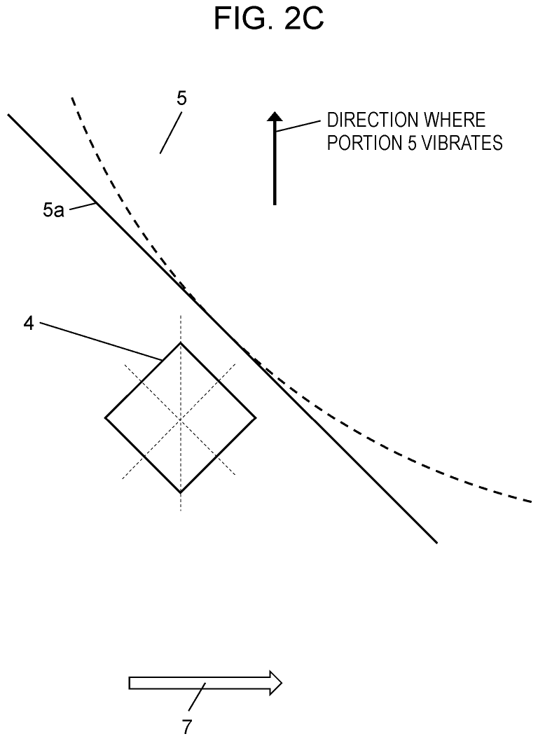

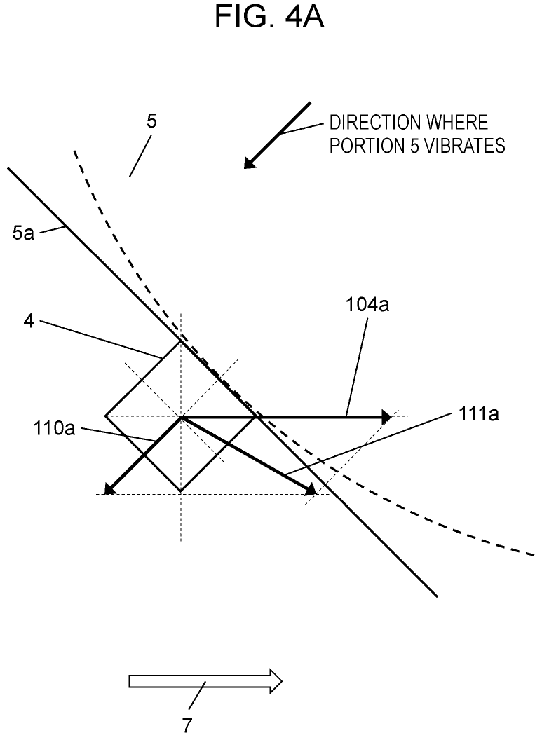

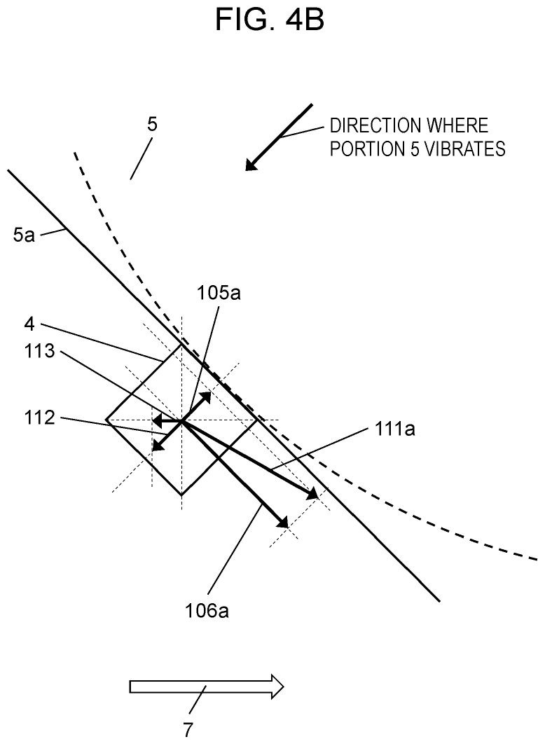

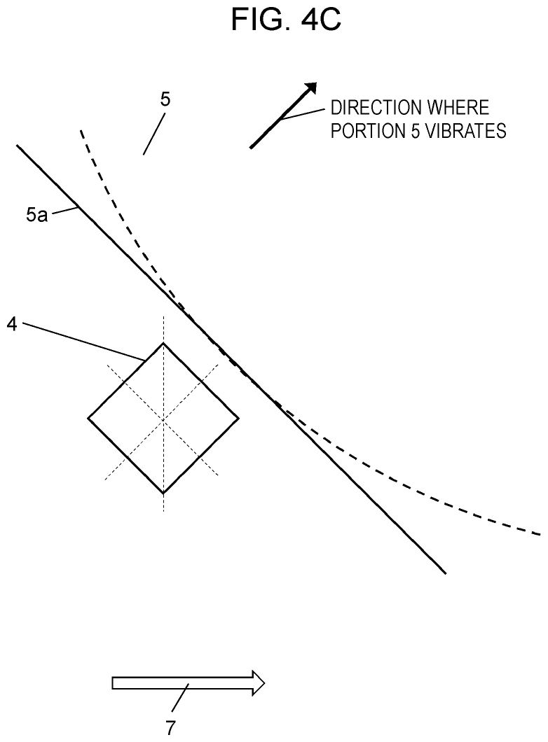

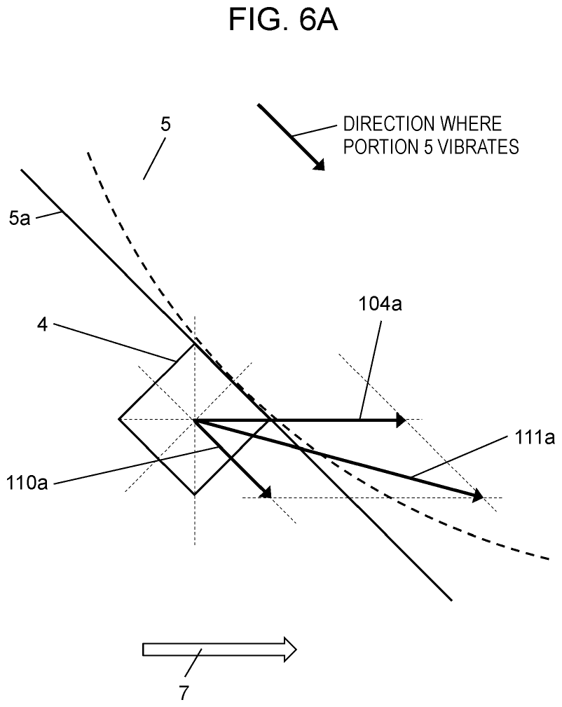

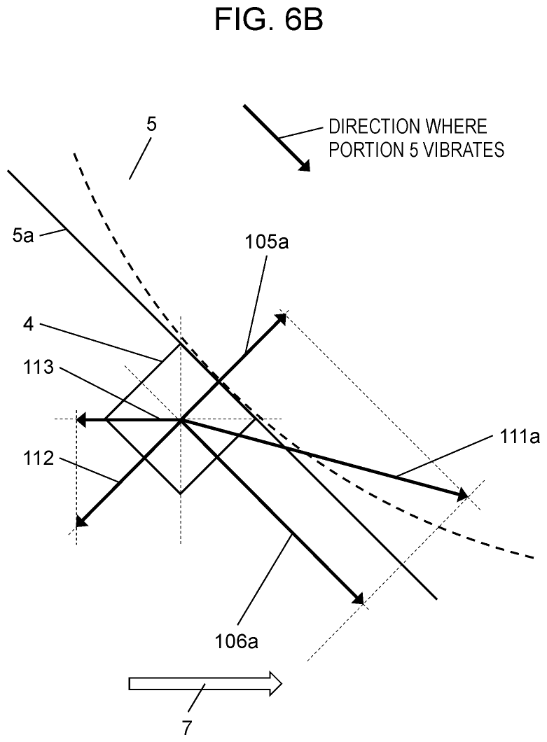

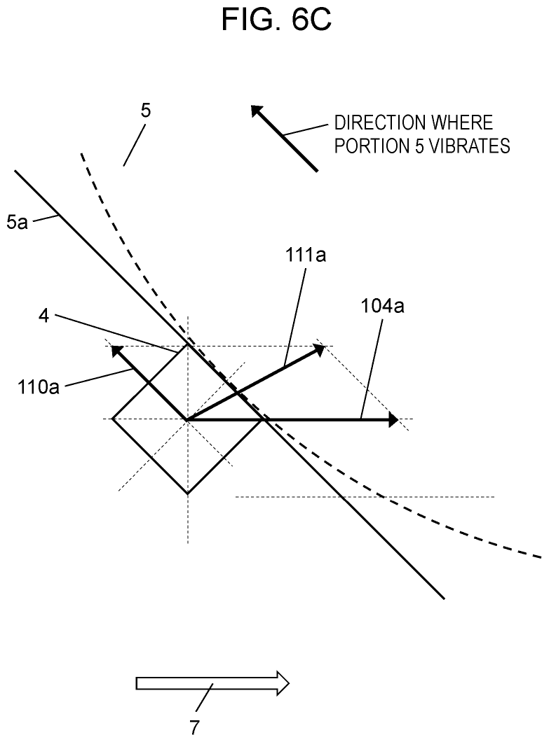

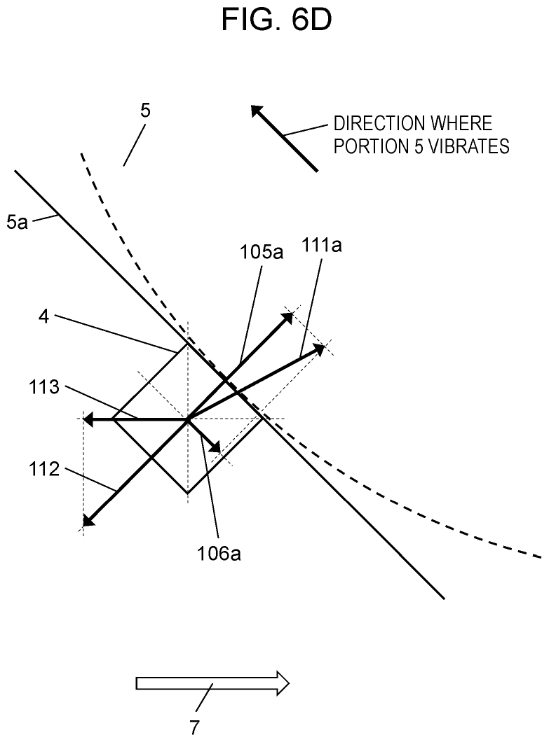

FIGS. 2A to 2C are vector diagrams illustrating force applied to powder 4 due to contact of powder 4 with surface 5a of portion 5 in a case where portion 5 is vibrated in a direction where an angle between surface 3a of base material 3 and a vibration direction of portion 5 is 90° in FIG. 1B. Although squeegee 1 in a flat shape is illustrated in FIGS. 2A to 2C, a vector diagram can be considered to be similar whether surface 5a of portion 5 is in an R shape or a flat shape. The same applies to FIGS. 4A to 4C and 6A to 6D below.

Here, FIG. 2A is a vector diagram illustrating force 111a (resultant force of force 104a causing powder 4 conveyed to base material 3 to push surface 5a of portion 5 and force 110a applied to powder 4 from portion 5 in vibration) that causes powder 4 to push surface 5a of portion 5 when surface 5a of portion 5 approaches base material 3 side (when squeegee 1 moves in a first direction during vibration). Furthermore, FIG. 2B is a vector diagram illustrating force 105a obtained by decomposing force 111a causing powder 4 to push surface 5a of portion 5 in FIG. 2A to vertically push surface 5a of portion 5, and force 112 received by powder 4 from portion 5 as drag against force 105a. Furthermore, FIG. 2C is a vector diagram illustrating a case where portion 5 is separated from base material 3 (a case where squeegee 1 moves in a second direction that is a direction opposite to the first direction during vibration).

In the case where portion 5 is vibrated to approach and to be separated from surface 3a of base material 3 such that the angle between the vibration direction of portion 5 and surface 3a of base material 3 is 90° as the present exemplary embodiment, when surface 5a of portion 5 approaches base material 3 side, as illustrated in FIG. 2A, the resultant force of force 104a causing powder 4 to push surface 5a of portion 5 by being conveyed to base material 3 and force 110a applied to powder 4 from surface 5a of portion 5 in vibration becomes force 111a causing powder 4 to push surface 5a of portion 5. As illustrated in FIG. 2B, force 111a causing powder 4 to push surface 5a of portion 5 is decomposed into force 105a causing powder 4 to vertically push the contact surface of surface 5a of portion 5, and force 106a for sliding on the contact surface of surface 5a of portion 5. At this time, powder 4 receives force 112 that is perpendicular to the contact surface of surface 5a of portion 5 and directed to the outer side of portion 5 as the drag against force 105a for vertically pushing the contact surface of surface 5a of portion 5.

Here, focusing on component 113 (force in a direction opposite to movement direction 7) obtained by decomposing force 112 that is perpendicular to the contact surface of surface 5a of portion 5 and directed to the outer side of portion 5, component 113 can be made smaller than that in the case shown in FIG. 12 where squeegee 150 does not vibrate (although FIG. 12 illustrates cylindrical squeegee 150, the same can be applied whether squeegee surface 151 is in the R shape or the flat shape). Therefore, in the present exemplary embodiment, retention of powder 4 can be suppressed on the upstream side of relative movement direction 7 of base material 3 with respect to squeegee 1. In other words, it is possible to obtain the effect of suppressing the occurrence of the bridge between squeegee 1 and base material 3.

Furthermore, similarly, focusing on force 106a obtained by decomposing force 111 causing powder 4 to push surface 5a of portion 5 to slide on the contact surface of surface 5a of portion 5, force 106a can be increased as compared with the case shown in FIG. 12 where squeegee 150 does not vibrate. Therefore, in the present exemplary embodiment, it is possible to obtain an effect of being capable of promoting powder 4 to enter into the gap between squeegee 1 and base material 3.

Furthermore, when surface 5a of portion 5 moves in a direction away from base material 3 while portion 5 vibrates, since surface 5a of portion 5 moves in a direction away from powder 4 as illustrated in FIG. 2C, surface 5a of portion 5 does not act on powder 4 to cause the retention and the occurrence of the bridge.

For such reasons, in the case where portion 5 is vibrated to approach and to be separated from surface 3a of base material 3 such that the angle between the vibration direction of portion 5 and surface 3a of base material 3 is 90°, it is possible to obtain the effect of suppressing the retention of powder 4 and the occurrence of the bridge and the effect of promoting powder 4 to enter into the gap between squeegee 1 and base material 3, as compared with the case shown in FIG. 12 where squeegee 150 does not vibrate. For such reason, even in the case where, for example, powder 4 having a very small particle diameter of several tens μm to submicron size is likely to aggregate and the fluidity of powder 4 is low, it is possible to crush powder 4 and evenly level the powder layer to make the thickness of the powder layer uniform, which is difficult in a conventional technique using squeegee 150 that does not vibrate as illustrated in FIG. 12.

Furthermore, as illustrated in FIGS. 13B and 13C, even in the conventional technique of vibrating squeegee 150 in relative movement direction 7 of base material 3 and the opposite direction of relative movement direction 7 (the vibration direction A in FIG. 11) while maintaining shortest distance 109 between squeegee 150 and base material 3, component 108 (the force in the direction opposite to relative movement direction 7 of base material 3) obtained by decomposing force 107 as drag applied to powder 4 from squeegee 150 is small compared to the case where squeegee 150 does not vibrate. Furthermore, since the component of force 106 for sliding on the contact surface of squeegee 150 (squeegee surface 151) becomes small, in the case where for example, powder 4 having a very small particle diameter of several tens μm to submicron size is likely to aggregate, and the fluidity of powder 4 is low, it is difficult to evenly level the powder layer to make the thickness of the powder layer uniform. However, in the present exemplary embodiment, by causing portion 5 to vibrate to approach and to be separated from surface 3a of base material 3 such that the angle between the vibration direction of portion 5 and surface 3a of base material 3 is 90°, powder 4 can be crushed and the powder layer can be evenly leveled to make the thickness of the powder layer uniform.

Here, in the case where portion 5 is vibrated to approach and to be separated from surface 3a of base material 3 such that the angle between the vibration direction of portion 5 and surface 3a of base material 3 is 90°, an effect of reducing frictional resistance of powder 4 can be obtained by vibrating portion 5 at the frequency, for example, from 2 kHz to 300 kHz inclusive. Furthermore, as a synergistic effect by the effect of reducing frictional resistance, a high effect of crushing and dispersing powder 4 can also be obtained by a flow of powder 4 entering into the gap between squeegee 1 and base material 3 from a powder reservoir on the upstream side of relative movement direction 7 of base material 3 with respect to squeegee 1, while a flow path is narrowed. Accordingly, it is possible to obtain an effect of improving the uniformity of an inner side of the powder layer to suppress aggregation and unevenness in addition to improvement of uniformity of the thickness of the powder layer.

Furthermore, in squeegee 1 of the present exemplary embodiment, portion 5 is vibrated to approach and to be separated from surface 3a of base material 3 such that the angle between the vibration direction of portion 5 and surface 3a of base material 3 is 90°. Furthermore, portion 6 can be vibrated while shortest distance 9 between surface 6a of portion 6 and base material 3 is being maintained. Accordingly, in squeegee 1 of the present exemplary embodiment, as compared with the case shown in FIG. 12 where squeegee 150 does not vibrate, it is possible to obtain the effect of suppressing the retention of powder 4 and the occurrence of the bridge and the effect of promoting powder 4 to enter into the gap between squeegee 1 and base material 3.

Here, the vibration direction of portion 6 may be vibration direction 13 parallel to relative movement direction 7 of base material 3 with respect to squeegee 1, or may be vibration direction 14 (back and front in the drawing) as a direction perpendicular to movement direction 7.

Accordingly, by vibrating portion 5 to approach and to be separated from surface 3a of base material 3 such that the angle between the vibration direction of portion 5 and surface 3a of base material 3 is 90°, the uniformity of the film thickness can be achieved while an increase in the variation in film thickness is suppressed, as well as the effect of suppressing the retention, the effect of suppressing the bridge, an effect of imparting the fluidity, and the effect of crush and dispersion are obtained.

For example, as a synergistic effect by the effect of reducing frictional resistance of powder 4 by vibrating squeegee 1 at the frequency from 2 kHz to 300 kHz inclusive, an effect of flattening the powder layer by vibrating portion 6 while shortest distance 9 between surface 6a of portion 6 and base material 3 is being maintained can be further improved.

Furthermore, powder 4 having a very small particle diameter of, for example, several tens μm to submicron size aggregates when the powder is in a stationary state, and the fluidity of powder 4 is lowered. In the present exemplary embodiment, by continuously treating powder 4 at a plurality of portions (portion 5 and portion 6) vibrating in different directions, it is possible to perform treatment at each portion (portion 5 and portion 6) of squeegee 1 while a state where the fluidity is imparted to powder 4 is being maintained. Therefore, it is possible to obtain many effects such as the effect of suppressing the retention, the effect of suppressing the bridge, the effect of crush and dispersion, and the uniformity of the film thickness.

### Second Exemplary Embodiment

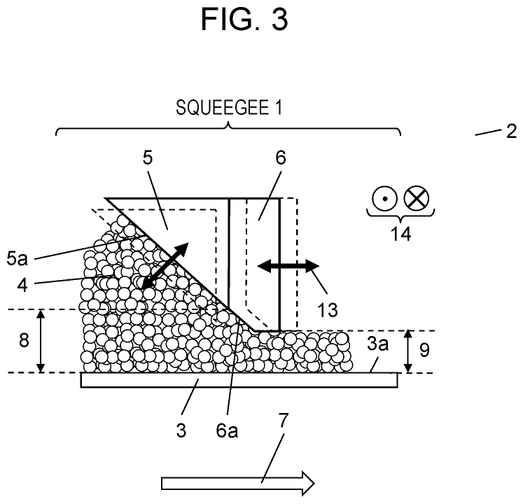

FIG. 3 illustrates a schematic view of squeegee 1 and powder coating apparatus 2 as the present exemplary embodiment.

The second exemplary embodiment is the same as the first exemplary embodiment except that squeegee 1 is vibrated in a direction where surface 5a of portion 5 and base material 3 approach each other on the upstream side and are separated from each other on the downstream side of relative movement direction 7 of base material 3 with respect to squeegee 1, rather than in the direction where the angle between the vibration direction of portion 5 and surface 3a of base material 3 is 90°. Therefore, differences from the first exemplary embodiment will be described below.

FIGS. 4A to 4C are vector diagrams illustrating force applied to powder 4 due to contact of powder 4 with surface 5a of portion 5 in a case where vibration is performed in a direction where portion 5 and surface 3a of base material 3 approach each other toward an upstream side and are separated from each other toward a downstream side of relative movement direction 7 of base material 3 with respect to squeegee 1, rather than in a direction where an angle between a vibration direction of portion 5 and surface 3a of base material 3 is 90° in FIG. 3.

Here, FIG. 4A is a vector diagram illustrating force 111a (resultant force of force 104a causing powder 4 to push surface 5a of portion 5 by being conveyed to base material 3 and force 110a applied to powder 4 from portion 5 in vibration) that causes powder 4 to push surface 5a of portion 5 when surface 5a of portion 5 approaches base material 3 side. Furthermore, FIG. 4B is a vector diagram illustrating force 105a obtained by decomposing force 111a causing powder 4 to push surface 5a of portion 5 in FIG. 4A to vertically push surface 5a of portion 5, and force received by powder 4 from portion 5 as drag against force 105a. Furthermore, FIG. 4C is a vector diagram illustrating a case where portion 5 is separated from base material 3.

In the case where the vibration is performed in a direction where portion 5 and surface 3a of base material 3 approach each other toward the upstream side and are separated from each other toward the downstream side of relative movement direction 7 of base material 3 with respect to squeegee 1 as the present exemplary embodiment, rather than in the direction where the angle between the vibration direction of portion 5 and surface 3a of base material 3 is 90°, when portion 5 and surface 3a of base material 3 approach each other toward the upstream side, as illustrated in FIG. 4A, the resultant force of force 104a causing powder 4 to push surface 5a of portion 5 by being conveyed to base material 3 and force 110a applied to powder 4 from surface 5a of portion 5 in vibration becomes force 111a causing powder 4 to push surface 5a of portion 5. As illustrated in FIG. 4B, force 111a causing powder 4 to push surface 5a of portion 5 is decomposed into force 105a for vertically pushing the contact surface of surface 5a of portion 5, and force 106a for sliding on the contact surface of surface 5a of portion 5. Powder 4 receives force 112 as the drag against force 105a for vertically pushing the contact surface of surface 5a of portion 5.

Here, focusing on component 113 of force 112, component 113 can be made smaller than that in the case shown in FIG. 12 where squeegee 150 does not vibrate (although FIG. 12 illustrates cylindrical squeegee 150, the same can be applied whether squeegee surface 151 is in the R shape or the flat shape). Therefore, in the present exemplary embodiment, retention of powder 4 can be suppressed on the upstream side of relative movement direction 7 of base material 3 with respect to squeegee 1. In other words, it is possible to obtain the effect of suppressing the occurrence of the bridge between squeegee 1 and base material 3.

Furthermore, similarly, focusing on force 106a obtained by decomposing force 111a causing powder 4 to push surface 5a of portion 5 to slide on the contact surface of surface 5a of portion 5, there is no change from the case shown in FIG. 12 where squeegee 150 does not vibrate, and force 106a is less likely to deteriorate than the case using the conventional technique illustrated in FIG. 13B.

For such reasons, in the present exemplary embodiment, by performing the vibration to cause portion 5 and base material 3 to approach each other toward the upstream side and to be separated from each other toward the downstream side of relative movement direction 7 of base material 3 with respect to squeegee 1, it is possible to obtain the effect of suppressing the retention of powder 4 and the occurrence of the bridge and the effect of promoting powder 4 to enter into the gap between squeegee 1 and base material 3 as compared with the case where the vibration is performed in relative movement direction 7 and the opposite direction (the vibration direction A in FIG. 11) of relative movement direction 7 while shortest distance 109 between cylindrical squeegee 150 and base material 3 is being maintained as the conventional techniques illustrated in FIGS. 13B and 13C. For example, even in the case where powder 4 having a very small particle diameter of several tens μm to submicron size is likely to aggregate, and the fluidity of powder 4 is low, it is possible to obtain the effect of improving the uniformity of the inner side of the powder layer to suppress the aggregation and the unevenness in addition to the improvement of the uniformity of the thickness of the powder layer. For such reason, it is possible to form a uniform powder layer having a thickness that less varies on surface 3a of base material 3 and having the aggregation and the unevenness suppressed inside.

Note that in the case where surface 5a of portion 5 and base material 3 are separated from each other on the downstream side of relative movement direction 7 of base material 3 with respect to squeegee 1, since surface 5a of portion 5 moves in a direction away from powder 4 as illustrated in FIG. 4C, surface 5a of portion 5 has little effect on powder 4 to suppress the retention and the occurrence of the bridge.

Furthermore, since the mode, the vibration, and the effect of portion 6 vibrating in contact with powder 4 on the downstream side of relative movement direction 7 of base material 3 with respect to squeegee 1 in the second exemplary embodiment are similar to the mode, the vibration, and the effect in the first exemplary embodiment, the description thereof will be omitted.

### Third Exemplary Embodiment

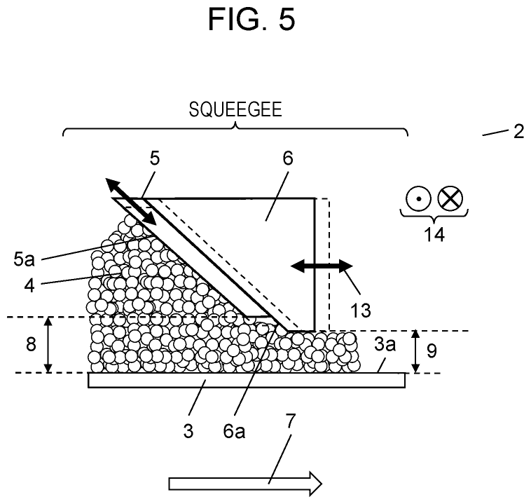

FIG. 5 is a schematic view of squeegee 1 and powder coating apparatus 2 as the present exemplary embodiment.

The present exemplary embodiment is the same as the first exemplary embodiment except that the vibration is performed in a direction where portion 5 and surface 3a of base material 3 approach each other toward the downstream side and are separated from each other toward the upstream side of relative movement direction 7 of base material 3 with respect to squeegee 1, rather than in the direction where the angle between the vibration direction of portion 5 and surface 3a of base material 3 is 90°. Therefore, only differences from the first exemplary embodiment will be described below.

In FIGS. 6A to 6D, surface 5a of portion 5 vibrating in contact with powder 4 on the upstream side of relative movement direction 7 of base material 3 with respect to squeegee 1 is not in the direction where the angle between the vibration direction of portion 5 and surface 3a of base material 3 is 90° in FIG. 5. Furthermore, FIGS. 6A to 6D are vector diagrams illustrating force applied to powder 4 due to contact of powder 4 with surface 5a of portion 5 in a case where portion 5 is vibrated to approach base material 3 toward a downstream side and to be separated from base material 3 toward an upstream side of relative movement direction 7 of base material 3 with respect to squeegee 1. Here, FIG. 6A is a vector diagram illustrating force 111a (resultant force of force 104a causing powder 4 to push surface 5a of portion 5 by being conveyed to base material 3 and force 110a applied to powder 4 from portion 5 in vibration) that causes powder 4 to push surface 5a of portion 5 when surface 5a of portion 5 approaches base material 3 on a downstream side of relative movement direction 7 of base material 3 with respect to squeegee 1. Furthermore, FIG. 6B is a vector diagram illustrating force 105a obtained by decomposing force 111a causing powder 4 to push surface 5a of portion 5 in FIG. 6A to vertically push surface 5a of portion 5, and force received by powder 4 from portion 5 as drag against force 105a. Furthermore, FIG. 6C is a vector diagram illustrating force 111a causing powder 4 to push surface 5a of portion 5 when portion 5 is separated from base material 3. Furthermore, FIG. 6D is a vector diagram illustrating force 105a obtained by decomposing force 111a causing powder 4 to push surface 5a of portion 5 in FIG. 6C to vertically push surface 5a of portion 5, and force received by powder 4 from portion 5 as drag against the force.

In the case where the vibration is performed in a direction where portion 5 and surface 3a of base material 3 approach each other toward the downstream side and are separated from each other toward the upstream side of relative movement direction 7 of base material 3 as the present exemplary embodiment, rather than in the direction where the angle between the vibration direction of portion 5 and surface 3a of base material 3 is 90°, when portion 5 and surface 3a of base material 3 approach each other toward the downstream side, as illustrated in FIG. 6A, the resultant force of force 104a causing powder 4 to push surface 5a of portion 5 by being conveyed to base material 3 and force 110a applied to powder 4 from surface 5a of portion 5 in vibration becomes force 111a causing powder 4 to push surface 5a of portion 5. As illustrated in FIG. 6B, force 111a causing powder 4 to push surface 5a of portion 5 is decomposed into force 105a causing powder 4 to vertically push the contact surface of surface 5a of portion 5, and force 106a for sliding on the contact surface of surface 5a of portion 5. Furthermore, powder 4 receives force 112 that is perpendicular to the contact surface of surface 5a of portion 5 and directed to the outer side of portion 5 as the drag against force 105a for vertically pushing the contact surface of surface 5a of portion 5.

Here, focusing on force 106a obtained by decomposing force 111a causing powder 4 to push surface 5a of portion 5 to slide on the contact surface of squeegee 1, force 106a can be made very large as compared with the case shown in FIG. 12 where squeegee 150 does not vibrate (although FIG. 12 illustrates cylindrical squeegee 150, the same can be applied whether squeegee surface 151 is in the R shape or the flat shape). Therefore, in the present exemplary embodiment, it is possible to obtain a high effect of being capable of promoting powder 4 to enter into the gap between squeegee 1 and base material 3.

Furthermore, similarly, powder 4 receives force 112 that is perpendicular to the contact surface of surface 5a of portion 5 and directed to the outer side from the inner side of portion 5 as the drag against force 105a for vertically pushing the contact surface of surface 5a of portion 5. Here, focusing on component 113 in the direction opposite to relative movement direction 7 of base material 3, component 113 is not likely to deteriorate as in the case shown in FIG. 12 where squeegee 150 does not vibrate (although FIG. 12 illustrates cylindrical squeegee 150, the same can be applied whether squeegee surface 151 is in the R shape or the flat shape).

Furthermore, in the case where the vibration is performed in a direction where portion 5 and surface 3a of base material 3 approach each other toward the downstream side and are separated from each other toward the upstream side of relative movement direction 7 of base material 3 with respect to squeegee 1, rather than in the direction where the angle between the vibration direction of portion 5 and surface 3a of base material 3 is 90°, when portion 5 and surface 3a of base material 3 are separated from each other toward the upstream side, as illustrated in FIG. 6C, the resultant force of force 104a causing powder 4 to push surface 5a of portion 5 by being conveyed to base material 3 and force 110a applied to the powder from surface 5a of portion 5 in vibration becomes force 111a causing powder 4 to push surface 5a of portion 5. As illustrated in FIG. 6D, force 111a causing powder 4 to push surface 5a of portion 5 is decomposed into force 105a for vertically pushing the contact surface of surface 5a of portion 5 and force 106a for sliding on the contact surface of surface 5a of portion 5, and powder 4 receives force 112 that is perpendicular to the contact surface of surface 5a of portion 5 and directed to the outer side from the inner side of portion 5 as the drag against force 105a for vertically pushing the contact surface of surface 5a of portion 5.

Here, focusing on force 106a obtained by decomposing force 111a causing powder 4 to push surface 5a of portion 5 to slide on the contact surface of surface 5a of portion 5, force 106a will be small compared to the case shown in FIG. 12 where squeegee 150 does not vibrate.

Furthermore, focusing on component 113 of force 112 received by powder 4 as the drag against force 105a for vertically pushing the contact surface of surface 5a of portion 5, component 113 is not likely to deteriorate as in the case shown in FIG. 12 where squeegee 150 does not vibrate (although FIG. 12 illustrates cylindrical squeegee 150, the same can be applied regardless of squeegee surface 151 being in the R shape or the flat shape).

Here, in the case where the vibration is performed in a direction where portion 5 and surface 3a of base material 3 approach each other toward the downstream side and are separated from each other toward the upstream side of relative movement direction 7 of base material 3 with respect to squeegee 1, rather than in the direction where the angle between the vibration direction of portion 5 and surface 3a of base material 3 is 90°, the states illustrated in FIGS. 6B and 6D are repeated. Attention is paid to force 106a obtained by decomposing force 111a causing powder 4 to push surface 5a of portion 5 to slide on the contact surface of surface 5a of portion 5. When portion 5 and base material 3 approaches each other toward the downstream side of relative movement direction 7 of base material 3 with respect to squeegee 1, force 106a for sliding on the contact surface of surface 5a of portion 5 can be made very large. In this case, it is possible to obtain the high effect of being capable of promoting powder 4 to enter into the gap between squeegee 1 and base material 3. Although force 106a for sliding on the contact surface of surface 5a of portion 5 is reduced when portion 5 and base material 3 are separated from each other toward the upstream side of relative movement direction 7 of base material 3 with respect to squeegee 1, it is possible to obtain the high effect of being capable of promoting powder 4 to enter into the gap between squeegee 1 and base material 3 during continuous vibration operation.

Furthermore, component 113 in the direction opposite to relative movement direction 7 of base material 3, of force 112 received by powder 4 as the drag against force 105a for vertically pushing the contact surface of surface 5a of portion 5 is not likely to deteriorate as in the case shown in FIG. 12 where squeegee 150 does not vibrate during the continuous vibration operation (although FIG. 12 illustrates cylindrical squeegee 150, the same can be applied regardless of squeegee surface 151 being in the R shape or the flat shape).

For such reason, by repeating operation in FIGS. 13B and 13, component 108 of force 107 that is directed to the outer side of the cylinder in the radial direction and received by powder 4 as the drag against force 105 for vertically pushing the contact surface of squeegee 150 can be reduced as compared with the case shown in FIG. 12 where squeegee 150 does not vibrate. In the conventional technique illustrated in FIG. 11, force 106 obtained by decomposing force 111 causing powder 4 to push squeegee 150 becomes small and deteriorate as compared with the case where squeegee 150 does not vibrate. However, in the case where the vibration is performed to cause surface 5a of portion 5 and base material 3 to approach each other toward the downstream side and are separated from each other toward the upstream side of relative movement direction 7 of base material 3 with respect to squeegee 1 as the present exemplary embodiment, force 106a for sliding on the contact surface of surface 5a of portion 5 becomes very large. Therefore, powder 4 can be promoted to enter into the gap between squeegee 1 and base material 3, and it is possible to obtain the effect of suppressing the retention of powder 4 and the occurrence of the bridge on the upstream side of relative movement direction 7 of base material 3 with respect to squeegee 1. As a result, since it is possible to obtain the effect of improving the uniformity of the inner side of the powder layer to suppress the aggregation and the unevenness in addition to the improvement of the uniformity of the thickness of the powder layer even in the case where powder 4 having a very small particle diameter of several tens μm to submicron size is likely to aggregate, and the fluidity of powder 4 is low, the uniform powder layer having less variation in thickness on surface 3a of base material 3 and no retention and unevenness inside can be formed.

Furthermore, since the mode, the vibration, and the effect of portion 6 vibrating in contact with powder 4 on the downstream side of relative movement direction 7 of base material 3 with respect to squeegee 1 in the third exemplary embodiment are similar to the mode, the vibration, and the effect in the first exemplary embodiment, the description thereof will be omitted.

Here, in one exemplary embodiment of the present disclosure, as an example of powder 4, the average particle diameter (D50) is from 0.005 μm to 50 μm inclusive, but similar effects can be obtained even with other particle diameters, and is not limited thereto.

The exemplary embodiments of the present disclosure will be described in more detail below by using specific experimental examples. Note that the present invention is not limited at all by the experimental examples below, and can be appropriately changed and carried out in a range without changing the gist.

### Experimental Examples

As an experimental example, positive electrode mixture layer 10, including positive electrode active material 11 and solid electrolyte 12, of an all-solid-state battery was formed into a film. LiNi1/3Co1/3Mn1/3 having an average particle diameter D50 of 5 μm was used as positive electrode active material 11, Li2S—P2S5 having an average particle diameter D50 of 0.8 μm was used as the solid electrolyte, and a mixture mixed at a volume ratio of 7:3 was formed into a film. Furthermore, the mixture was supplied onto base material 3 on the upstream side of relative movement direction 7 of base material 3 with respect to squeegee 1, and formed into a film having an application width of 50 mm, an application length of 200 mm, and a film thickness of 300 μm on an aluminum foil to be base material 3 by leveling the mixture with squeegee 1 in the first exemplary embodiment to third exemplary embodiment. A coating speed was 10 m/min. Furthermore, the vibration conditions of portion 5 vibrating in contact with powder 4 on the upstream side and portion 6 vibrating in contact with powder 4 on the downstream side of relative movement direction 7 of base material 3 with respect to squeegee 1 were the same, a vibration frequency was 35 kHz, and an amplitude was 5 μm.

Furthermore, portion 5 vibrating in contact with powder 4 on the upstream side of relative movement direction 7 of base material 3 with respect to squeegee 1 was vibrated in a direction where the angle between base material 3 and the vibration direction was 90° in the first exemplary embodiment, vibrated in a direction where the angle between base material 3 and the vibration direction of portion 5 was 45° on the upstream side of relative movement direction 7 of base material 3 with respect to squeegee 1 in the second exemplary embodiment, and vibrated in a direction where the angle between base material 3 and the vibration direction of portion 5 was 45° on the downstream side of relative movement direction 7 of base material 3 with respect to squeegee 1 in the third exemplary embodiment.

Furthermore, in each exemplary embodiment, film formation was performed for the case where portion 6 vibrating in contact with powder 4 on the downstream side of relative movement direction 7 of base material 3 with respect to squeegee 1 was vibrated in relative movement direction 7 of base material 3 with respect to squeegee 1 and the opposite direction of relative movement direction 7, and the case where portion 6 was vibrated in the direction perpendicular to relative movement direction 7 of base material 3 with respect to squeegee 1.

Furthermore, as comparative examples, the film formation was similarly performed for a case (Comparative Example 1) where cylindrical squeegee 150 was vibrated in relative movement direction 7 of base material 3 with respect to squeegee 150 and the opposite direction (the vibration direction A in FIG. 11) of relative movement direction 7 while shortest distance 109 between squeegee 150 and base material 3 was being maintained as the conventional technique illustrated in FIG. 11, and a case (Comparative Example 2) where cylindrical squeegee 150 was vibrated in the direction (the vibration direction B in FIG. 11) perpendicular to relative movement direction 7 of base material 3 with respect to squeegee 150 while shortest distance 109 between squeegee 150 and base material 3 was being maintained. Here, as vibration conditions of squeegee 150, a vibration frequency of squeegee 150 was set to 700 Hz and an amplitude was set to 5 μm, which are conditions disclosed in PTL 2.

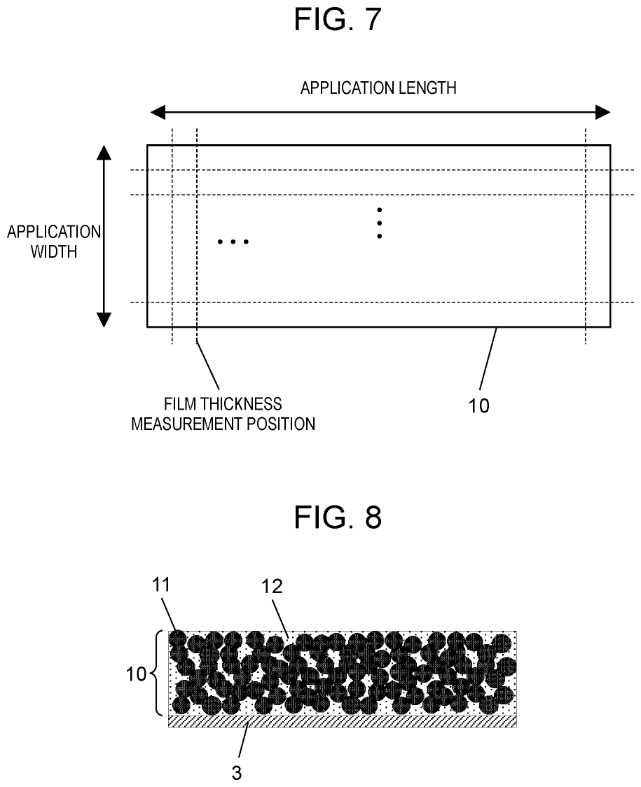

The variation in film thickness in a surface of positive electrode mixture layer 10 obtained was measured to cross the powder layer at intervals of 5 mm in an application width direction and an application direction, respectively, as illustrated in FIG. 7 by using a laser displacement meter, and as a maximum value of the variation in film thickness ((maximum value of film thickness−minimum value)/(average value of film thickness)) in each powder layer, a value of less than ±2.5% was defined as “A”, a value of more than or equal to ±2.5% and less than ±5% was defined as “B”, and a value of more than or equal to ±5% was defined as “C”.

Furthermore, in a case where a cross section of positive electrode mixture layer 10 as illustrated in FIG. 8 is observed, a total area of aggregated portions of solid electrolyte 12 having a cross-sectional area of more than or equal to 100 μm² was measured, and a ratio of the total area of aggregated portions to the cross-sectional area of positive electrode mixture layer 10 of less than 2% is defined as “A”, more than or equal to 2% and less than 10% is defined as “B”, and more than or equal to 10% is defined as “C”.

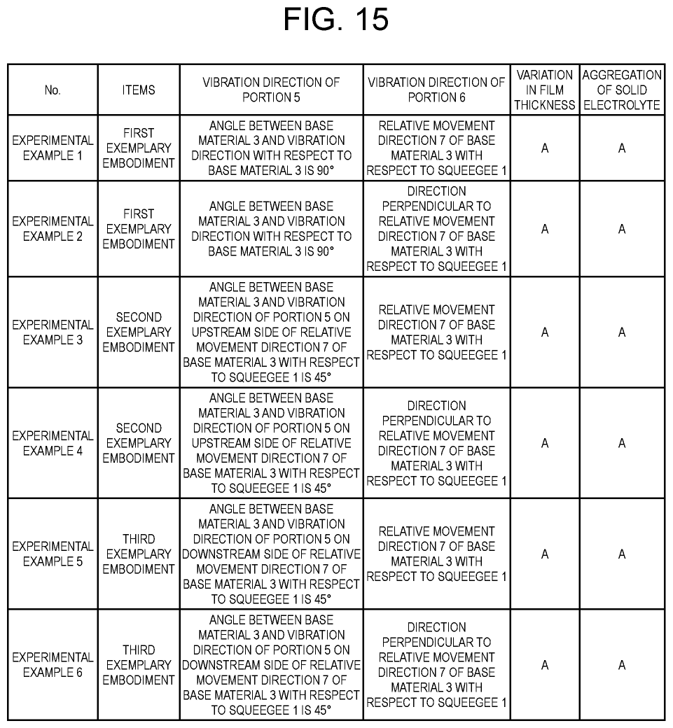

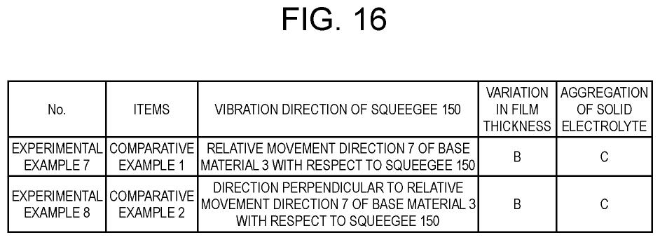

Results of each exemplary embodiment according to the present disclosure are shown in Table 1 in FIG. 15. Furthermore, results of the comparative examples according to the conventional technique are shown in Table 2 in FIG. 16.

In Experimental Examples 1 to 6 as one exemplary embodiment of the present disclosure, the vibration direction of portion 5 vibrating in contact with powder 4 on the upstream side and the vibration direction of portion 6 vibrating in contact with powder 4 on the downstream side of relative movement direction 7 of base material 3 with respect to squeegee 1 are different, both the effect of suppressing the retention of powder 4 and the occurrence of the bridge and the effect of promoting powder 4 to enter into the gap between squeegee 1 and base material 3 can be obtained under any condition, and both reduction of the variation in film thickness and suppression of aggregation of solid electrolyte 12 can be achieved.

On the contrary, in Experimental Examples 7 to 8, where cylindrical squeegee 150 is vibrated while shortest distance 109 between squeegee 150 and base material 3 is being maintained as the conventional technique, the film formation can be performed, although not sufficient, with a certain level of variation in film thickness, but both the reduction of the variation in film thickness and the suppression of the aggregation of solid electrolyte 12 cannot be achieved. If, for example, a higher frequency condition is used in order to obtain the high effect of crushing and dispersing powder 4, an improvement tendency in an aggregation state can be observed, but a tendency of increasing variation in film thickness can also be observed. On the contrary, if, for example, a low frequency condition is used in order to suppress the variation in film thickness, an improvement effect on the variation in film thickness is observed, but the aggregation state tends to deteriorate.

Accordingly, in the conventional technique of vibrating cylindrical squeegee 150 while maintaining shortest distance 109 between squeegee 150 and base material 3, it is difficult to achieve both assurance of film thickness accuracy and uniformity of film quality. On the contrary, in the present exemplary embodiments, where the vibration direction of portion 5 vibrating in contact with powder 4 on the upstream side and the vibration direction of portion 6 vibrating in contact with powder 4 on the downstream side of relative movement direction 7 of base material 3 with respect to squeegee 1 are different, it is possible to achieve both the accuracy and the uniformity.

Here, in the present exemplary embodiments, the group of particles including the active material is used as an example of powder 4, but similar effects can also be obtained in powder of other functional materials, and raw materials, compositions, particle shapes, and particle diameters are not particularly limited.

Furthermore, powder 4 may include only one type of powder, or may include two or more types of powder. In a case where powder 4 is a mixture powder including a plurality of types of powder, when vibration at a high frequency near the ultrasonic band is applied to squeegee 1 to flatten powder 4, dispersity of powder 4 including the plurality of types of powder is improved. In other words, powder 4 including the plurality of types of powder is easily dispersed, and a specific type of powder in powder 4 is less likely to be unevenly formed on base material 3 into a film. It is considered that due to the vibration of squeegee 1 at the high frequency near the ultrasonic band, the vibration at the high frequency near the ultrasonic band is transmitted to powder 4 existing in a certain region before reaching squeegee 1, and since a plurality of types of particles constituting powder 4 vibrate and flow, the plurality of types of particles constituting powder 4 are mixed with each other to improve the dispersity.

Furthermore, base material 3 is a long thin plate, and is unwound from a wound state, and then wound up after being coated, but base material 3 is not limited to such form. Base material 3 having a desired shape may be relatively moved by drive unit 19 with respect to squeegee 1, and after finishing coating of powder 4, new base material 3 may be intermittently moved relative to squeegee 1 by drive unit 19. Furthermore, base material 3 may not be wound in a roll shape. Base material 3 is not limited to a sheet shape, and may have any shape as long as powder 4 can be coated by using powder coating apparatus 2. Furthermore, in the present exemplary embodiments, base material 3 is a current collector including the metal foil, but a raw material of the base material 3 is not particularly limited, and any base material can be used as long as the base material 3 can be coated with powder 4 by using powder coating apparatus 2.

(Other Modifications and the Like)

Although the present disclosure has been described above based on the first exemplary embodiment to the third exemplary embodiment, the present disclosure is not limited to the first exemplary embodiment to the third exemplary embodiment or the like.

In addition, the present disclosure also includes a mode obtained by applying each type of modification conceived by those skilled in the art to the first exemplary embodiment to the third exemplary embodiment, and a mode achieved by appropriately combining components and functions of the first exemplary embodiment to the third exemplary embodiment in a range without departing from the gist of the present disclosure.

According to the present disclosure, it is possible to form the powder layer with less variation in film thickness on the surface of the base material.

### INDUSTRIAL APPLICABILITY

Since the squeegee and the powder coating apparatus of the present disclosure can produce a uniform powder layer with less variation in film thickness without using a solvent, the squeegee and the powder coating apparatus can also be applied to a use of forming, for example, a mixture layer of a high-quality energy device (for example, an all-solid-state battery).

### REFERENCE MARKS IN THE DRAWINGS

1: squeegee
2: powder coating apparatus
3: base material
3a: surface of base material
4: powder
5: portion (first portion)
5a: surface of portion 5
6: portion (second portion)
6a: surface of portion 6
7: relative movement direction of base material with respect to squeegee
8: shortest distance between portion 5 and base material
9: shortest distance between portion 6 and base material
10: positive electrode mixture layer
11: positive electrode active material
12: solid electrolyte
13: vibration direction of portion 6 parallel to relative movement direction 7 of base material 3 with respect to squeegee 1
14: vibration direction of portion 6 perpendicular to relative movement direction 7 of base material 3 with respect to squeegee 1
18: powder supply unit
19: drive unit
100: blade-shaped squeegee in conventional method
101: surface of blade-shaped squeegee in conventional method
102: force causing powder to vertically push contact surface of squeegee
103: force in direction opposite to movement direction of powder (relative movement direction of base material (metal foil) with respect to squeegee)
104: force causing powder to push squeegee by being conveyed to base material
104a: force causing powder 4 to push surface 5a of portion 5 by being conveyed to base material 3
105: force for vertically pushing contact surface of squeegee
105a: force for vertically pushing contact surface of surface 5a of portion 5
106: force for sliding on contact surface of squeegee
106a: force for sliding on contact surface of surface 5a of portion 5
107: force directed to outer side of cylinder in radial direction
108: component in direction opposite to relative movement direction 7 of base material with respect to squeegee
109: shortest distance between squeegee and base material
110: force applied to powder from squeegee in vibration
110a: force applied to powder 4 from portion 5 in vibration
111: force that is resultant force of force 104 causing powder 4 to push squeegee 150 by being conveyed to base material 3 and force 110 applied to powder 4 from squeegee 150 in vibration, and that causes powder 4 to push squeegee 150
111a: force that is resultant force of force 104a causing powder 4 to push surface of portion 5 by being conveyed to base material 3 and force 110a applied to powder 4 from surface 5a of portion 5 in vibration, and that causes powder 4 to push surface 5a of portion 5
112: force that is perpendicular to contact surface of surface 5a of portion 5 and directed to outer side from inner side of portion 5 as drag against force 105a for vertically pushing contact surface of surface 5a of portion 5
113: component in direction opposite to relative movement direction 7 of base material 3 with respect to squeegee 1, of force 112 that is perpendicular to contact surface of surface 5a of portion 5 and directed to outer side from inner side of portion 5
150: cylindrical squeegee in conventional method
151: surface of cylindrical squeegee in conventional method

1. A squeegee that is moved relative to a base material in a direction while a desired gap is being formed between the squeegee and the base material to uniformly level a thickness of a powder layer including powder supplied onto the base material, the squeegee comprising:
a first portion that vibrates in contact with the powder on an upstream side of a relative movement direction of the base material with respect to the squeegee; and
a second portion that vibrates in contact with the powder on a downstream side of the relative movement direction of the base material with respect to the squeegee,
wherein the first portion has a vibration direction that is different from a vibration direction of the second portion.

2. The squeegee according to claim 1, wherein
the vibration direction of the first portion is a direction where the powder is crushed, and
the vibration direction of the second portion is a direction where the powder is flattened.

3. The squeegee according to claim 2, wherein
the vibration direction of the first portion is a direction where a surface of the first portion vibrating in contact with the powder approaches and is separated from the base material, and
the vibration direction of the second portion is a direction where the second portion vibrates while a shortest distance between a surface of the second portion vibrating in contact with the powder and the base material is being maintained.

4. The squeegee according to claim 3, wherein the vibration direction of the first portion is a direction perpendicular to the base material.

5. The squeegee according to claim 3, wherein the vibration direction of the second portion is parallel to the relative movement direction of the base material with respect to the squeegee.

6. The squeegee according to claim 3, wherein the vibration direction of the second portion is orthogonal to the relative movement direction of the base material with respect to the squeegee.

7. The squeegee according to claim 1, wherein the first portion and the second portion are vibrated at a frequency from 2 kHz to 300 kHz inclusive.

8. A powder coating apparatus comprising:
a powder supply unit that supplies powder onto a surface of a base material;
the squeegee according to claim 1 that is disposed to allow a gap to be formed between the squeegee and the base material, and adjusts a thickness of a powder layer including the powder supplied onto the base material; and
a drive unit that relatively moves the base material and the squeegee in a direction.
